(19) United States
(12) Patent Application Publication
(10) Pub. No.: US 2017/0268293 A1
(43) Pub. Date: Sep. 21, 2017

(54) Device for manually operating a motorized drive of a screen, such as a window covering, and method for saving setting values associated with different positions of the screen

(71) Applicant: Coulisse B.V., Enter (NL)

(72) Inventors: Ruben Hubert Jan de Vries, Zevenaar (NL); Bastiaan Franciscus Klein Tuente, Groenlo (NL); Harry Davids, Utrecht (NL); Wouter Hendriks, Enschede (NL)

(21) Appl. No.: 15/458,776

(22) Filed: Mar. 14, 2017

(30) Foreign Application Priority Data
Mar. 17, 2016 (NL) 2016447
Dec. 23, 2016 (EP) 16206681.5

(51) Int. Cl. E06B 9/74; E06B 9/72; E06B 9/78

(52) U.S. Cl. CPC E06B 9/74; E06B 9/78; E06B 9/72; E06B 2009/785; E06B 2009/6818

(57) ABSTRACT

The invention relates to a device (1) for manually operating a motorized drive of a screen, such as a window covering. A housing (2) to be attached to the screen comprises first operating means (3) and second operating means (20) for manual operation of the device.

Switching means (10) convert pulling movements on the first operating means into first electrical signals for the motorized drive.

Control means (4) are configured to save a setting value associated with a current position of the screen in memory means after receiving second electrical signals from the second operating means (20).

The invention likewise relates to a method for saving setting values associated with different positions of a screen, such as a window covering, which screen is provided with a motorized drive and a device according to the invention, comprising the step of saving a current position by manual operation of the first or second operating means.

The invention relates to a device for manually operating a motorized drive of a screen, such as a window covering, comprising a housing to be attached to the shaft of the screen;

first operating means for manual operation of the device by means of pulling movements by a user;
switching means for converting the pulling movements on the first operating means into first electrical signals for the motorized drive.

Such a device is known in the relevant field, for instance from EP1182321. In the known device the switching means comprise electrical contacts which make direct contact with an electric motor.

The known device combines the advantages of an electric motor with the convenience of use of a traditional operation with pulling movements on a cord. The pull cord moreover requires no loop, whereby the known device also meets the current requirements in the field of child safety.

The present invention has for its object to further improve the device according to the preamble.

The device according to the invention has for this purpose the feature that the switching means comprise a switch which generates a first electrical signal in a first mode and generates a second electrical signal in a second mode, wherein the switching means further comprise a switching element for connection to the first operating means, wherein the switching element is movable between a first position, in which the switch takes up the first mode, and a second position in which the switching element activates the switch in the second mode, and the device comprises control means for controlling the motorized drive on the basis of the first electrical signals.

The switching means comprise only one switching element and a switch, and can therefore take a compact form. The addition of control means, preferably a microprocessor, increases the possibilities of the device according to the invention and makes it applicable in diverse types of motorized transmission.

In an optimal preferred embodiment of the device according to the invention the switching element is a rotation element, which rotation element is rotatable about a rotation axis running substantially parallel to the screen shaft. The rotatable switching element has the significant advantage that the pulling movement is converted into a rotational movement, during which the rotation element is moved along the switch, which enables the switching means to take a very compact form.

According to an elegant preferred embodiment of the device according to the invention, the rotation element comprises a central body with a first radially protruding lip.

According to a practical preferred embodiment of the device according to the invention, the rotation element comprises a central body with a second radially protruding lip for connection to the manual operating means.

In a further preferred embodiment the device according to the invention comprises biasing means for urging the rotation element into the first position. The biasing means make it possible to set the required tensile force.

In a first preferred embodiment of the device according to the invention the switch comprises a sensor and the switching element comprises a number of associated signal generators. The switching means take a contactless form, this resulting in reduced wear and a longer lifespan. According to an advantageous and reliable development of the first preferred embodiment, the switch comprises a magnetic sensor and the switching element comprises a number of magnets. In an energy-saving embodiment the magnetic sensor is a Hall sensor. In an elegant and compact preferred embodiment one or more of the magnets are arranged on the first radially protruding lip of the switching element embodied as rotation element.

In a second preferred embodiment of the device according to the invention the switching means comprise a switch configured to perform a translating movement between the first mode and the second mode, wherein the switching element is movable between a first position, in which the switching element does not make contact with the switch, and a second position in which the switching element makes contact with the switch for actuating the translating movement of the switch. The switching element and the switch are movable along substantially parallel movement axes and the switching means can therefore take a very compact form. The device according to the invention, wherein the switching element is a rotation element, further has the significant advantage that the rotation element slides along the switch, whereby the switching means do not transmit the tensile force on the cord directly to the switch. Overloading of the switch is thereby prevented.

In a preferred embodiment of the device according to the invention the rotation element has an at least partially non-uniform thickness. The non-uniform thickness ensures a gradual force transmission to the switch when the rotation element slides over the switch.

According to a further preferred embodiment, the first mode is an OFF-mode in which the switch does not generate an electrical signal and the second mode is an ON-mode in which the switch generates an electrical signal.

The switch is preferably configured to close an electrical circuit in which a power supply and the motorized drive are incorporated.

The invention also relates to a device according to the preamble of claim 1, characterized in that the device is further provided with second operating means for generating second electrical signals, which second operating means are manually operable, wherein the control means are configured to save a setting value associated with a current position of the screen in the memory means after receiving the second electrical signals.

The improved device according to the invention has the advantage that programming of a current mode of the screen can take place directly in manual manner. This enhances the convenience of use and the user-friendliness. In an elegant preferred embodiment the second operating means comprise an operating button, preferably a push button.

According to an elegant preferred embodiment, the current position of the screen is a first or a second end position which bounds the movement of the screen.

The control means preferably comprise a microcontroller for controlling the motorized drive. In a first preferred embodiment of the device according to the invention which is safe for children the operating means comprise a cord or chain.

In a second preferred embodiment of the device according to the invention which is safe for children the operating means comprise a rod.

In a preferred embodiment the screen is a roller blind and the device according to the invention is further provided with a motor unit which is coupled to the housing, wherein the motor unit comprises a tubular motor housing for the motorized drive, which is to be received in a roller blind tube.

The invention likewise relates to a method for saving setting values associated with different positions of a screen, such as a window covering, which screen is provided with a motorized drive and a device according to the invention, comprising the step of saving a current position by manually operating the first operating means and/or the second operating means. The method according to the invention has the significant advantage that programming of screen positions can always take place directly, without the device having to be brought into a programming mode. The manual operation provides here an improved user-friendliness and an improved convenience of use.

The invention will now be described with reference to the figures, in which

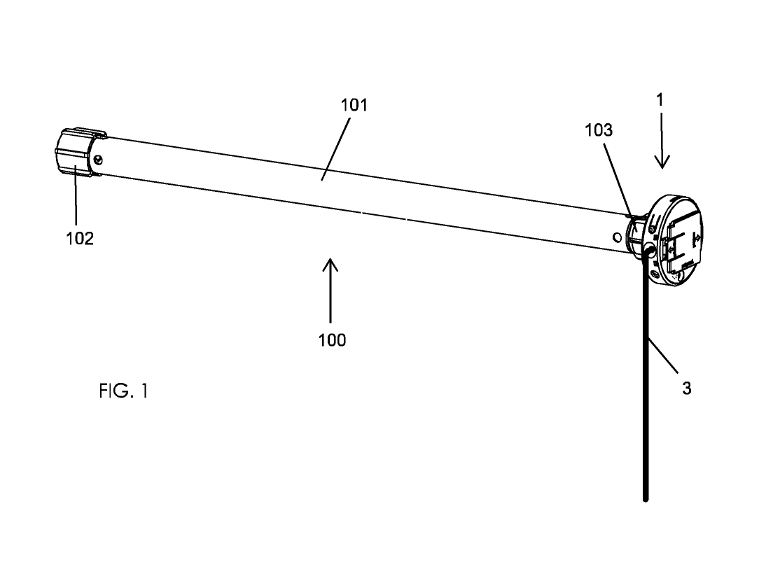

FIG. 1 shows a schematic view of a preferred embodiment of the device according to the invention incorporated in a motor unit for a roller blind;

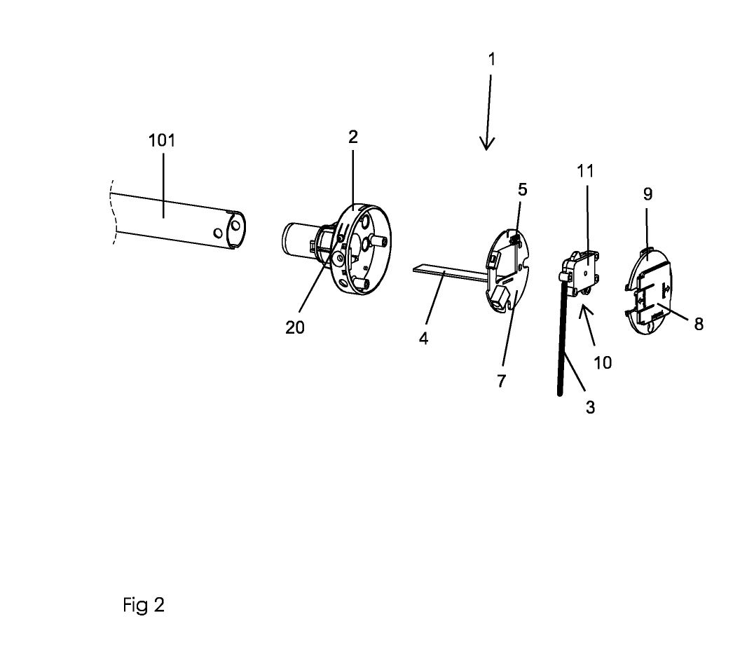

FIG. 2 shows a schematic view of the device of FIG. 1 with exploded parts;

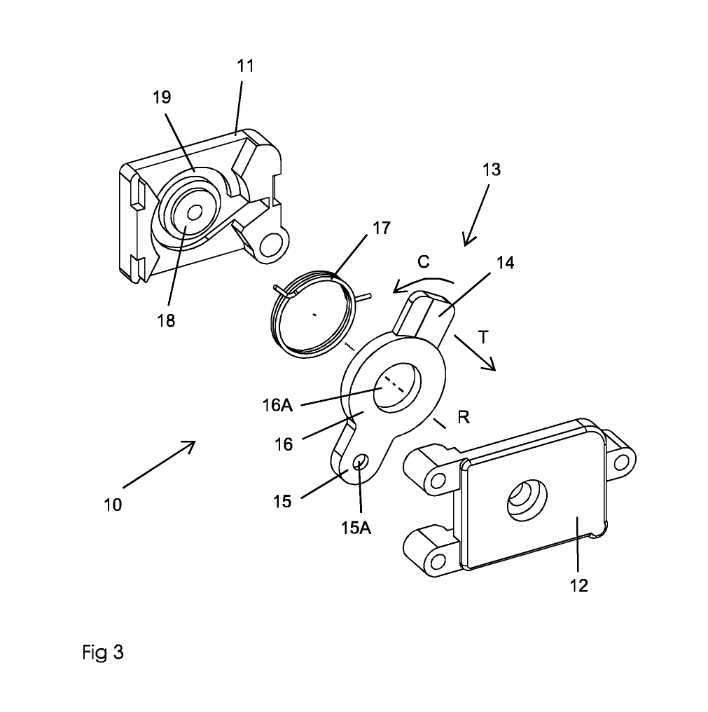

FIG. 3 shows a schematic view of a part of the device of FIG. 2 with exploded parts;

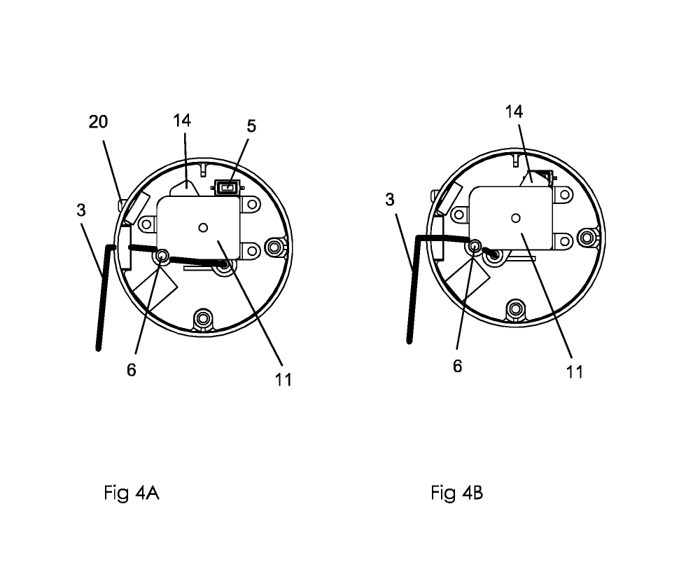

FIG. 4A shows a schematic cross-sectional view through the device according to FIG. 1 in a first position;

FIG. 4B shows a schematic cross-sectional view through the device according to FIG. 1 in a second position;

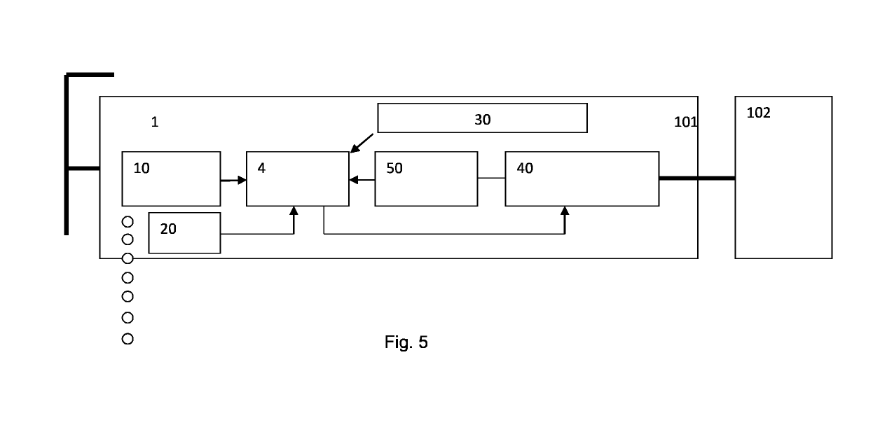

FIG. 5 shows a block diagram of the preferred embodiment of FIG. 1; and

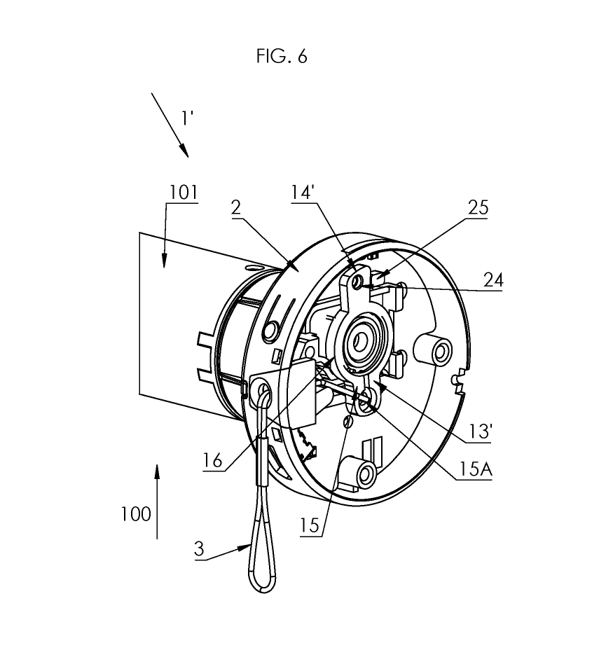

FIG. 6 shows a schematic view of a second preferred embodiment of the device according to the invention with broken-away parts.

FIG. 1 shows a schematic view of a preferred embodiment of a device 1 for manually operating a motorized drive of a screen, such as a window covering. In the shown preferred embodiment device 1 is intended for operating a roller blind. FIG. 1 shows a motor unit 100 with a generally tubular motor housing 101 to be received in a roller blind tube (not shown). Situated in motor housing 101 is a motorized drive, such as an electric motor. This electric motor drives a drive plug 102 which is situated at the outer end of motor housing 101. Situated at the opposite outer end is a crown or slide bearing 103, as well as a device 1 according to the invention. Device 1 can be operated by means of a pull cord 3.

FIG. 2 shows a schematic view of device 1 of FIG. 1 with exploded parts. Device 1 comprises a housing 2 to be attached to the screen, in this preferred embodiment to be received in motor housing 101. Device 1 further comprises control means 4 for controlling the motorized drive. Suitable control means 4 are for instance a microcontroller.

Device 1 further comprises switching means for converting the pulling movements on pull cord 3 into electrical signals. The switching means comprise a (pressure) switch 5 which is configured to perform a translating movement between a first mode and a second mode. The first mode is preferably an OFF-mode in which the pressure switch does not generate an electrical signal. The second mode is preferably an ON-mode in which the pressure switch does generate an electrical signal. Pressure switch 5 can for instance close an electrical circuit in which the electric motor and control means 4 are incorporated together with a power supply. The switch is preferably a microswitch. The switching means further comprise switching means in the form of a mechanical switching mechanism 10 for operating pressure switch 5 with pull cord 3.

Control means 4 and pressure switch 5 are arranged on a mounting plate 7. Housing 2 further comprises a closing plate 9 with mounting means 8 for mounting the roller blind on a surface.

FIG. 3 shows the mechanical switching mechanism 10 with exploded parts. Switching mechanism 10 comprises a first housing part 11 and a second housing part 12, which enclose a rotation element 13 and biasing means 17. Rotation element 13 has a central body 16 with a central opening 16A and is rotatable in rotation direction C about a rotation axis R. A first lip 14 extends in radial direction from central body 16. First lip 14 has an at least partially non-uniform thickness which increases counter to the rotation direction C. This can be achieved by a chamfering of first lip 14. A second lip 15 extends in radial direction from central body 16. Second lip 15 is provided with an eye 15A for attachment of pull cord 3. First housing part 11 is provided with a shaft 18 to be received in the central opening 16A of rotation element 13. A groove 19 for receiving biasing means 17 runs around shaft 18. In the shown preferred embodiment the biasing means comprise a torsion spring.

FIGS. 4A and 4B each show a schematic cut-away view of device 1, wherein switching mechanism 10 is assembled in housing 2. Pressure switch 5 is situated in housing 2. Situated some distance from pressure switch 5 is a bushing 6. In assembled state of device 1 bushing 6 serves to guide pull cord 3.

FIG. 4A shows rotation element 13 in a first position. Operating pull cord 3 causes rotation element 13 to move to the second position shown in FIG. 4B. After pull cord 3 is released the rotation element will return to the position in FIG. 4A under the influence of biasing means 17. During movement of rotation element 13 first lip 14 slides over pressure switch 5, as a result of which this performs a translating movement in the direction T. The direction T runs substantially parallel to the direction of rotation axis R. Pressure switch 5 is in this way operated by pulling movements on pull cord 3. Pressure switch 5 is in electrical connection with control means 4, which are in electrical connection with the motorized drive.

FIG. 5 shows schematically a block diagram of a device according to the invention. Device 1 comprises switching means for converting pulling movements on the first operating means by a user into first electrical signals. The switching means preferably comprise an electric switch and a mechanical actuator for the electric switch, which is connected to the first operating means. Suitable switching means are for instance the switching mechanism 10. Device 1 is further provided with second operating means 20 for generating second electrical signals. Second operating means 20 can preferably be manually operated and comprise an operating button, preferably a push button.

Motor 40 and power supply 30 are situated in motor housing 101 of motor unit 100. Motor housing 101 further comprises measuring means 50 for determining a setting value associated with a current position of the screen. Suitable measuring means comprise an encoder, which preferably measures the rotation of the primary shaft of the electric motor using a sensor such as a Hall sensor.

Device 1 further comprises a data memory for saving the setting values. Device 1 preferably comprises a microcontroller 4 in which are incorporated the control means, the program memory, the data memory and input and output ports (I/O) for communication with peripheral equipment, such as measuring means 50 and switching means 10 and operating button 20. After receiving the second electrical signals, device 1 will save the current position of the screen as a first or a second end position. The movement of the screen is bounded by the end positions.

In the shown preferred embodiment microcontroller 4, measuring means 50 and motorized drive 40 are incorporated in an electrical circuit with a power supply 30. Power supply 30 is preferably a current source, such as battery, which is preferably rechargeable. First operating means 10 generate the first electrical signals by closing the electrical circuit in the ON-mode and breaking the electrical circuit in the OFF-mode. The first electrical signals comprise information about the pulling movements, such as the number of pulling movements, duration of a pulling movement, duration between successive pulling movements, order of pulling movements or combinations thereof.

Second operating means 20 likewise generate the second electrical signals by closing the electrical circuit. The second electrical signals comprise information about the pushing movements, such as the number of pushing movements, duration of a pushing movement, duration between successive pushing movements, order of pushing movements or combinations thereof.

Device 1 comprises means for controlling the motorized drive. The control means receive the first electrical signals from the switching means and can translate these signals into commands for the motorized drive. Device 1 comprises a program memory in which the instructions for processing the first electrical signals are saved.

According to the invention, device 1 can be programmed manually by means of first operating means 3 and/or second operating means 20.

Control means 4 are configured for this purpose to save the setting value associated with the current position of the screen in the data memory after receiving the second electrical signals. These control means comprise a second set of additional instructions for processing the second electrical signals. This second set of additional instructions is preferably saved in the program memory of the microcontroller.

Control means 4 are further configured to save the setting value associated with the current position of the screen as an intermediate position in the data memory after receiving predetermined first electrical signals.

These control means comprise a first set of additional instructions for processing the predetermined first electrical signals. This first set of additional instructions is preferably saved in the program memory of the microcontroller.

FIG. 6 shows a schematic view of a second preferred embodiment of the device according to the invention with broken-away parts. The broken-away parts are closing plate 9 with mounting means 8 and the second housing part 12 of switching mechanism 10. These are shown in FIG. 2.

Like components of the two preferred embodiments have like reference numerals. Similar components of the two preferred embodiments are designated with the same reference numeral with added accent. Examples are device 1′, rotation element 13′, first lip 14′. In the case of new components with the same function the reference numerals are increased by the number 20.

Device 1′ is distinguished by contactless switching means with an electric or electronic switch 25 instead of a (pressure) switch 5. Contactless switch 25 comprises a sensor, preferably a Hall sensor. The switching element or rotation element 13′ comprises a number of magnets. In the shown second preferred embodiment rotation element 13′ comprises a magnet 24 which is arranged on the first radially protruding lip 14′. Lip 14′ does not require chamfering. The Hall sensor measures a magnetic field and converts it into a control signal. The sensor functions as wireless and contactless receiver. As alternative to the Hall sensor, other sensors which measure other physical quantities, for instance radiation, are in principle also suitable to form the contactless switch. The associated co-acting wireless and contactless signal generators, for instance magnet 24 or a radiation source, are generally mounted on a mechanically movable switching element. In the first and second preferred embodiment the switching element is a rotation element. The switching element can however also be a translation element, for instance a slide, or consist of a plurality of parts movable relative to each other.

In both preferred embodiments the switching means comprise a switch (sensor 25 or (pressure) switch 5), which generates a first electrical signal in a first mode and generates a second electrical signal in a second mode. In the first mode the first electrical signal can be zero and the switch is in the OFF-mode. In the second mode the second electrical signal can differ from zero and the switch is in the ON-mode. In both preferred embodiments the switching means further comprise a switching element, such as rotation element 13, 13′, for connection to first operating means 3. Switching element 13, 13′ is movable between a first mode, in which the switch is in the first position, and a second mode in which the switching element activates the switch in the second position.

In device 1′ rotation element 13′ is rotatable about a rotation axis R which runs substantially parallel to the longitudinal axis of tubular motor housing 101. In assembled state this longitudinal axis runs parallel to the screen shaft, i.e. the shaft of the roller blind tube. The operation of the device according to the invention is illustrated on the basis of the following examples with method steps.

### EXAMPLE 1: OPERATING A SCREEN WITHOUT PROGRAMMED END POSITIONS

As long as a user operates first operating means 3 by means of a first pulling movement (for instance pulls the pull cord continuously), the motor runs and the screen moves.

Performing the first pulling movement again results in a reversal of the direction in which the motor runs, whereby the screen moves in the opposite direction.

### EXAMPLE 2: PROGRAMMING AN END POSITION

Operating the second operating means 20 with a first pushing movement at the position where the motor is stationary results in the current screen position being programmed as first end position.

The device optionally generates a confirmation signal when an end position has been saved successfully. An example of a confirmation signal is the motor moving back and forth once. A light signal is another example. The screen has to be moved to a second end position, after which the foregoing steps can be repeated for programming the second end position.

### EXAMPLE 3: OPERATING A SCREEN WITH PROGRAMMED END POSITIONS

When a user operates the first operating means with a second pulling movement (for instance 1 short pull) when the motor is stationary, the screen moves to one of the two end positions.

The motor stops when the second pulling movement is repeated.

Performing the second pulling movement again results in a reversal of the rotation direction of the motor, whereby the screen moves in the opposite direction, to the other end position.

### EXAMPLE 4: DELETING ALL POSITIONS

Operating the second operating means 20 with a second pushing movement (for instance pushing continuously for a prolonged period of time, such as 5 seconds) results in the memory being cleared. The control means return to the factory values.

The device optionally generates the confirmation signal when the memory is in danger of being cleared (for instance after 2 seconds).

The device optionally generates the confirmation signal again when the memory has been successfully cleared (for instance after 5 seconds).

### EXAMPLE 5: PROGRAMMING AN INTERMEDIATE POSITION

Operating the first operating means with a third pulling movement (for instance pulling continuously for a determined period of time, such as 5 seconds) results in the current screen position being programmed as intermediate position.

The device optionally generates the confirmation signal when the intermediate position has been saved successfully.

### EXAMPLE 6: OPERATING A SCREEN WITH PROGRAMMED INTERMEDIATE POSITION

When a user operates the first operating means with a fourth pulling movement (for instance pulling continuously for a determined period of time, such as 2 seconds, or two short pulls) when the motor is stationary, the screen moves to the intermediate position.

### EXAMPLE 7: DELETING AN INTERMEDIATE POSITION

Performing the third pulling movement when the current screen position is the intermediate position results in the intermediate position being cleared from the memory.

The device optionally generates the confirmation signal when the intermediate position has been successfully cleared from the memory.

The control means preferably comprise software for evaluating the first electrical signals coming from the first operating means and for evaluating the second electrical signals coming from the second operating means, and for generating commands for controlling the motor or saving the setting value associated with the current position of the screen when predetermined first or second electrical signals are received/recognized. A skilled person in the field will be able to develop suitable software after reading of this text.

Although the first operating means are illustrated in the shown preferred embodiment as a pull cord, it will be apparent to a skilled person in the field that they can also be formed by alternative manual operating means, including a chain or a rod.

The invention is illustrated on the basis of a motor unit for a roller blind.

The device according to the invention is however applicable to diverse types of screen with a motorized drive. A skilled person in the field will be able to effect co-action of the device according to the invention with diverse suitable motors and transmissions of screens, such as window coverings, after reading of this text.

The invention is expressly not limited to the described and shown embodiment, but comprises all variants thereof which fall within the scope of protection of the appended claims, as seen in the light of the accompanying figures.

1. Device for manually operating a motorized drive of a screen, such as a window covering, comprising
a housing to be attached to the shaft of the screen;
first operating means for manual operation of the device by means of pulling movements by a user;
switching means for converting the pulling movements on the first operating means into first electrical signals for the motorized drive, characterized in that
the switching means comprise a switch which generates a first electrical signal in a first mode and generates a second electrical signal in a second mode, wherein the switching means further comprise a switching element for connection to the first operating means, wherein the switching element is movable between a first position, in which the switch takes up the first mode, and a second position in which the switching element activates the switch in the second mode, and the device comprises control means for controlling the motorized drive on the basis of the first electrical signals.

2. Device as claimed in claim 1, wherein the switching element is a rotation element, which rotation element is rotatable about a rotation axis running substantially parallel to the screen shaft.

3. Device as claimed in claim 2, wherein the rotation element comprises a central body with a first radially protruding lip.

4. Device as claimed in claim 3, wherein the rotation element comprises a central body with a second radially protruding lip for connection to the manual operating means.

5. Device as claimed in claim 2, comprising biasing means for urging the rotation element into the first position.

6. Device as claimed in claim 1, wherein the switch comprises a sensor and the switching element comprises a number of associated signal generators.

7. Device as claimed in claim 6, wherein the switch comprises a magnetic sensor and the switching element comprises a number of magnets.

8. Device as claimed in claim 7, wherein the magnetic sensor is a Hall sensor.

9. Device as claimed in claim 7 with reference to claim 3, wherein one or more of the magnets are arranged on the first radially protruding lip.

10. Device as claimed in claim 1, wherein the switching means comprise a switch which is configured to perform a translating movement between the first mode and the second mode, wherein the switching element is movable between a first position, in which the switching element does not make contact with the switch, and a second position in which the switching element makes contact with the switch for actuating the translating movement of the switch.

11. Device as claimed in claim 1, wherein the first mode is an OFF-mode in which the switch does not generate an electrical signal and wherein the second mode is an ON-mode in which the switch generates an electrical signal.

12. Device as claimed in claim 1, wherein the switch is configured to close an electrical circuit in which a power supply and the motorized drive are incorporated.

13. Device as claimed in claim 1, wherein the control means comprise a microcontroller for controlling the motorized drive.

14. Device as claimed in claim 1, wherein the screen is a roller blind and wherein the device is further provided with a motor unit which is coupled to the housing, wherein the motor unit comprises a tubular motor housing for the motorized drive, which is to be received in a roller blind tube.

15. Method for saving setting values associated with different positions of a screen, such as a window covering, which screen is provided with a motorized drive and a device for manually operating a motorized drive of a screen, such as a window covering, comprising a housing to be attached to the shaft of the screen; first operating means for manual operation of the device by means of pulling movements by a user; switching means for converting the pulling movements on the first operating means into first electrical signals for the motorized drive, characterized in that the switching means comprise a switch which generates a first electrical signal in a first mode and generates a second electrical signal in a second mode, wherein the switching means further comprise a switching element for connection to the first operating means, wherein the switching element is movable between a first position, in which the switch takes up the first mode, and a second position in which the switching element activates the switch in the second mode, and the device comprises control means for controlling the motorized drive on the basis of the first electrical signals, comprising the step of saving a current position by manually operating the first operating means.
